(19) United States
(12) Patent Application Publication
(10) Pub. No.: US 2003/0061232 A1
(43) Pub. Date: Mar. 27, 2003

(54) Method and system for processing business data

(75) Inventor: Eugene C. Patterson, Fair Haven, NJ (US)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: DUN & BRADSTREET INC.

(21) Appl. No.: 09/957,968

(22) Filed: Sep. 21, 2001

(51) Int. Cl. G06F 7/00

(52) U.S. Cl. 707/104.1

(57) ABSTRACT

A method and system that collects data from resources connected to a network for addition to a database that contains data records for businesses. A database of URL records is built according to a data structure that includes data elements that are useful to determine if an entity described by the data elements qualifies as a business. The data elements of the two databases are used to form web mining strategies. A distributing processing system is used to mine huge numbers of web pages in parallel. The bandwidth and transmission times are shortened at the distributed device end by summarizing web page content in an index that is returned to a central processor in the form of a byte. The central processor analyzes the byte and earmarks for a complete content extraction only those web pages that have enough business content.

### FIELD OF THE INVENTION

This invention relates to a method and system that mines and processes data acquired from resources connected to a network.

### BACKGROUND OF THE INVENTION

Dun and Bradstreet (D&B), the assignee of the present application, has collected and processed information or data concerning the activities of businesses and made available reports based on this data for nearly 160 years. A data framework and an integration framework is used to create a database of business information. The data framework first looks at a value chain of a customer to determine what type of information needs to be supplied to the customer. This information has value to a customer so as to make better business decisions for the business activities of the value chain.

Referring to FIG. 1, a value chain 30 includes a purchase cycle 32 and a sales cycle 34. In purchase cycle 32, the customer needs to find suppliers that produce or provide the type of goods or services required for the customer's business endeavor. This activity is frequently called sourcing. When found, a supplier must be qualified to a set of qualifications. For example, one qualification is the ability to deliver. Once qualified, an actual buy transaction must be executed to procure the goods and/or services. Purchase cycle 32 is repeated for each supplier required for the customer's endeavor. When the necessary goods and services have been procured from one or more suppliers, the customer then makes the product or provides the service of the endeavor, as signified by make box 36.

Purchase cycle 34 begins with the task of finding a buyer for the customer's goods and/or services. This activity is called marketing. Once found, a potential buyer must be qualified according to a set of qualifications. For example, one qualification is credit, which involves the buyer's ability to pay. When a buyer has been found and qualified, an actual sell transaction must be executed.

The data that is relevant to finding a supplier or a buyer is basically the same. This data includes groups of data elements necessary to sort potential suppliers and buyers by various criteria, as well as a group of data elements necessary to contact these suppliers and buyers. Data elements necessary for sorting reflect the basic criteria that differentiate businesses from one another. These criteria involve answering three questions, namely, what do they do, how big are they, and where are they located?

The “what do they do” question can be answered by assigning a service industry code (SIC code). The SIC code is a hierarchical set of classifications that describes the kind of products that a company makes and, by implication, the kind of products that the company is likely to buy.

The “how big are they” question can be answered in two ways, namely by measuring the revenue level that a company generates and by looking at the number of employees. The “where are they located” question is simply answered by providing the company's physical address.

Contact information falls into two basic categories. In small to medium sized companies, most decisions are made by the chief executive officer (CEO). In larger companies, decision making is usually delegated downward to various managers. Therefore, for small to medium sized companies, the CEO name is typically provided, and for larger companies, the names of specific functional decision-makers are provided. Along with either the CEO or individual functional manager contact names the company's mailing address and main phone number are also provided.

Customers typically want a rating or score to qualify suppliers and buyers. These scores are derived by applying rules to a number of data elements. Referring to FIG. 2, various types of business data 38 can be supplied to the customer. Business data 38 includes, for example, a financial condition 40, a delivery score 42, a delivery experience 44, a credit score 46 and a payment experience 48. Financial condition 40 can be estimated by looking at historic accounting information that ranges from simple revenue numbers up to and including full financial statements, and also by looking at some leading indicators of what a company's financial position might be in the future.

Leading indicators are of several types. For example, one leading indicator is legal information that indicates a spectrum of potential liability. At the lowest end of this spectrum, a suit indicates a potential future liability. Further along the spectrum, a lien or judgement means that a legal action has been taken that will result in a specific future liability. At the far end of the spectrum, a bankruptcy clearly means trouble for a company's buyers and suppliers.

Other leading indicators are special events. For example, a report of a fire or major disaster at a business location could clearly mean trouble. Other events are more subtle. For example, a change in control means that new owners have taken over and may change a company's behavior for good or ill. The historic financial information and the various leading indicator information are combined into a financial model to assess the potential future financial condition of the company.

Payment experiences 48 indicate the company's actual history of on-time or delayed payments. This information is completely quantitative and can be exactly measured from accounts payable data received from D&B's data suppliers. Delivery experiences 44 indicate a company's actual history of deliveries. This is somewhat more subjective and measures a person's perception of these deliveries along dimensions of on-time delivery, condition of goods or services received, after sale customer support and so forth.

Credit score 46 represents a credit-scoring model. At a very high level, the credit-scoring model may be quite simple. For example, four quadrants can represent combinations of good and bad financial condition and good and pad payment experiences. A good financial condition combined with a good payment history indicates that a company is a good credit risk. A bad payment history combined with a bad financial condition indicates that a company is a bad credit risk. A good payment history combined with a bad financial condition indicates that that payments might suddenly get worse and, while the company may be a good credit risk now, it should be watched in the future. A bad payment history combined with a good financial condition either indicates that the company is just slow paying its bills or that it might get better in the future. Delivery score 42 can be used to develop a delivery score along the same four quadrants, with analogous meanings

D&B also collects data other than that described above. Some of this data helps verify the existence of a business and is collected from various state and other registrars. Basically, this other data enables the flagging of a particular business name and address registered as a potential business, and the registration data often provides some high level contact name and other information.

The term “business” is difficult to define. There is a spectrum of activity that runs from a person doing purely consumer oriented things, through a person doing business-like things on a part time basis, to a person working in a full time home based business, to a person or persons working for a formally defined traditional organization. The term “entity” will be used herein to define any set of activities along this spectrum done by an individual or a set of individuals. Thus an entity may be a person or a business depending on how the definitions are established. Each of these entities in turn generates information that can be collected.

The D&B integration framework describes how all of the data should be put together in a database and how the critical processes surrounding this database work. A basic rule of the integration framework is that information about a given entity is first collected and then evaluated to see if the entity exhibits a critical mass of business-like behavior. In other words, it is often impossible to tell if an entity is a business or not before the data is collected, but when the collected data is examined this determination can often be made. From a process perspective, this means that entity data must first be collected, stored, evaluated for business characteristics, and assigned some type of business identity (ID). To do the initial collection, every entity must have some type of ID that will uniquely differentiate one entity from another.

The steps of a data collection procedure for the Integration Framework include selection of an entity ID, selection of data to be collected, build a supply chain, collect entity data and assign business IDs.

The step of selecting an entity ID requires that the entity ID be both omnipresent and globally unique. Since entity data is collected before any type of standard classification is attempted, a given entity data transaction must already carry enough information to enable it to be uniquely identified and stored in a database. This information is referred to as an “Entity ID” and can be any field or set of fields that is likely to be common to all potential input transactions. For example, the combination of business name and address may suitably serve as the Entity ID, as name and address data is very likely to be present on every type of entity transaction.

The Entity ID must not only identify a given entity, but also must differentiate between one entity and another. The combination of business name and address is globally unique. Business names themselves are locally unique. For example, there may be many “Joe's Bars” throughout the United States, but there are fewer in any given city, more than likely to be only one on any given street in a city, and virtually certain to be only one at a given street address in a given city.

The step of selecting the set of data to be collected determines what parts or data elements of the customer's value chain should be collected. For example, a provider of full services all across the value chain might choose to collect all of the data elements defined in the data framework.

The step of collecting the data requires the data collector to build and maintain a supply chain. This involves first mapping data requirements to potential data sources, and then putting the processes and procedures in place to obtain data from these sources. The data elements come from a variety of sources. The address (physical and mail), size (revenue and employees), people (contact names and titles), and financial (revenue & income numbers up to full financial statements) come directly from the subject business. Legal information comes from a wide number of local, state and federal courts. Payment and delivery experience data must, by definition, come from the trading partners who interact in a buying and selling relationship with the subject business. Finally, registration data comes from a wide variety of state and other sources.

After mapping the required information to suppliers, the data collector must establish relationships with the various collection sources, and put processes and procedures in places to acquire information on a regular basis. Collection relationships must be established with all of the businesses for which data is being collected. For example, D&B has collection relationships with over 13 million businesses. Automated calling centers also must be established to periodically (e.g., annually) place telephone calls to most of these businesses. Further, direct or intermediary relationships must be established to acquire data from over 2,600 court locations in the United States and with over 6,000 major trading partners who supply accounts receivable files containing payment experiences of their trading partners. Finally, relationship must be established with over 50 state and other sources to get registration files.

The step of collecting entity data requires the data collector to write input programs to translate the data from various input formats of the sources to a format required to load the data into the collector's database. For example, a call-center system may be established where data from millions of phone calls is entered in the correct format of the collector's database. In the legal areas, software must be written that can accept information directly from court locations (via laptops) or in bulk form various intermediary compilers of legal information. In the trading partner area, programs must be written to accept many different accounts payable tape formats from the various providers. For registration data, different programs must be written to accept registration data from various sources. With all of these programs in place, entity level data is continuously loaded into the collector's databases for subsequent analysis and assignment of a business ID.

Before a business ID can be assigned, the collected entity level information must be evaluated to see if the entity is a business or not. This evaluation is a two step process, which is performed periodically. In the first step each entity is identified to see if it is already in the portion of the collector's database that has been assigned business ID's. If the entity can be matched, the information contained by the entity updates the information already collected. If the entity cannot be matched, it is then examined to see if it has a critical mass of business-like attributes. If it does, then the entity is assigned a new business ID.

Entity and business matching is a complex process, because business names and addresses are quite complex. A business name is completely nonstandard. In addition, a company may have more than one business name, for example, a legal name and a series of other names called trade styles. Information on a business is often collected simultaneously under a number of trade styles, and all of this has to be tied together.

Business addresses are even more complex. Because addresses have multiple parts (floor, suite, office etc at a street address, the street address itself, the street name, city or town, state, and zip code) even the same address is often coded incorrectly or incompletely on various transactions. In fact, the US Post Office puts out a 128-page book devoted solely to how to address mailed items. As with business names, a company may have more than one address for the same business operation, for example, a physical address, a mailing address for correspondence and a ship to address for bulk items. Finally, business addresses frequently change. Transactions about the same company may be coded to the physical, mail or delivery addresses. Depending on the timing, any or all of these addresses may have changed over time, and some transactions will be coded to the old address, and some to the new. Therefore, a matching database must be developed that not only normalizes business names and addresses, but also includes the various aliases and historical values. Given that there are millions of business names and addresses this becomes a considerable business challenge.

Once matching has been completed, entities that do not match may or may not be new businesses. To make this determination, the collected data elements must be examined to determine if they contain a critical mass of evidence that the entity is a business. For example, if an entity reveals in a telephone conversation that it is a business, if it is registered as a business, if it has one or more payment experiences with trading partners, and if it has had legal actions filed against it, it is probably a business. On the other hand, some lesser levels of evidence might suffice. If several vendors have payment experiences, and the entity is registered in a state that requires a more rigorous level of evidence about business registrations this might be enough. The point is that there are a series of business rules that can be applied to the various collected data elements to make a determination if a given entity is a business. With millions of records in a database, the data collector can apply these rules, cross check the results, and statistically correlate how well any given rule works with a high degree of accuracy.

A new business ID is then assigned to an entity if it passes the application of these rules. The business ID used by D&B is a Duns Number, which is a globally unique nine-digit number that identifies a business at a location. For most businesses one Duns Number is enough because most businesses only have a single operation at a single location. For those businesses that have more than one operation and/or more than one location several Duns Numbers may be assigned. In this case, one location is selected as a headquarters and all of the other Duns Numbers are linked to it. This is called a family tree and is used to tie together complex businesses all over the world.

The procedures that collect business data are largely manual requiring a large number of people to collect the data and enter the data into the collector's database. These procedures require considerable time and are labor intensive.

Thus, there is a need to automate various steps of the data collection procedure to reduce time and labor and, hence, reduce cost.

### SUMMARY OF THE INVENTION

The method and system of the present invention acquires data from resources connected to a network, such as the Internet or World Wide Web. The acquired data is processed for entry as a new business into a database containing data for a plurality of businesses, to verify or validate or update the data of the businesses or to add value to the existing database.

Broadly, the method of the present invention verifies business data of the database by looking up a first profile data for a business using at least one uniform resource locator (URL). Also, a second profile data for said business is looked up using a business identifier. A comparison of the first and second profile data is made to verify that the second profile data is valid.

According to one aspect of the invention, the second profile data is updated with any of the first profile data that differs from the second profile data. According to another aspect of the invention, additional profile data is obtained from one or more the resources to update the second profile data.

According to another aspect of the present invention, if the second profile data is not found in the database, it is determined if the first profile data qualifies as a business. If so, a business identifier is assigned thereto to form a new business profile data for addition to the database.

More specifically, the profile data includes separate profile data records with each record including a plurality of data elements. The data records of the URL profile data are identified by the corresponding URLs. The data records of the business database are identified by associated business identifiers. The URL data records and the business data records are compared for a match. Additional data is acquired from the resources for addition to the URL data records, which are then analyzed for qualification as a business. If qualified, a URL record is formed as a new business profile record with an assigned business identifier for addition to the business database.

According to second embodiment of the present invention, a plurality of URL records is maintained in a first database that includes a plurality of fields for each URL record. A plurality of business data records is maintained in a second database that includes a plurality of fields for each business data record. A mining strategy is derived from data elements stored in one or more of the fields of the first and second databases to mine data elements from the network resources for storage in the fields of said first database.

According to an aspect of the second embodiment of the invention, it is determined if the data elements of a first URL record of the first database describe a business. If so, a new business data record is formed based on the data elements of the first URL record for storage in the second database and a new business identifier is assigned thereto. According to another aspect, business reports are provided based on the data elements of the first database, the second database, or both.

According to a third embodiment of the invention, data mining is distributed among a number of supplier devices from a central computing system with server capability. The central server serves URLs to the distributed supplier devices. A supplier device forms an index of the content of web page by a URL and returns the index to the central server. The transmission of a URL and the return of an index, which may be in the form of a byte, considerably shortens the bandwidth and the transmission time, thereby allowing an extremely large number of URLs to be processed in parallel. The returned indices are examined by the central server to eliminate from consideration those web pages that do not have business content in the index. This considerably shortens the number of web pages that need a complete content extraction.

According to a fourth embodiment of the invention, the content of a web page is arranged into a plurality of content categories that are formed into an index that summarizes the content categories. According to an aspect of the fourth embodiment, the content categories are expressed as values.

According to a fifth embodiment of the invention, a plurality of web pages for mining a business content is filtered by eliminating any of the web pages that contain adult content or that fail a prediction test that predicts which pages are likely to contain business content. The remaining web pages are then mined for business content.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a chart depicting a prior art value chain;

FIG. 2 is a chart depicting a prior art extension of the FIG. 1 chart to data collection;

FIG. 3 is a block diagram of a system that includes the system of the present invention;

FIG. 4 is a block diagram of the computer system of the FIG. 1 system;

FIG. 5 depicts the data framework of the URL database of the FIG. 3 system;

FIG. 6 is a process flow diagram of part of the business data program of the FIG. 4 computer system;

FIG. 7 depicts process flow diagrams for data mining aspects of the business data program of the FIG. 4 computer system;

FIG. 8 depicts a distributed processing aspect of the system of FIG. 1;

FIG. 9 depicts an alternative distributed processing aspect of the system of FIG. 1;

FIG. 10 is a process flow diagram for data mining aspects of the business data program of the FIG. 4 computer system;

FIG. 11 is a process flow diagram of the business data program of the computer system of FIG. 4;

FIG. 12 is an additional process flow diagram of the business data program of the computer system of FIG. 4;

FIG. 13 is a block diagram depicting the distributed indexing capability of the computer system and supplier devices of the communication system of FIG. 3; and

FIG. 14 depicts a caller ID system of the present invention.

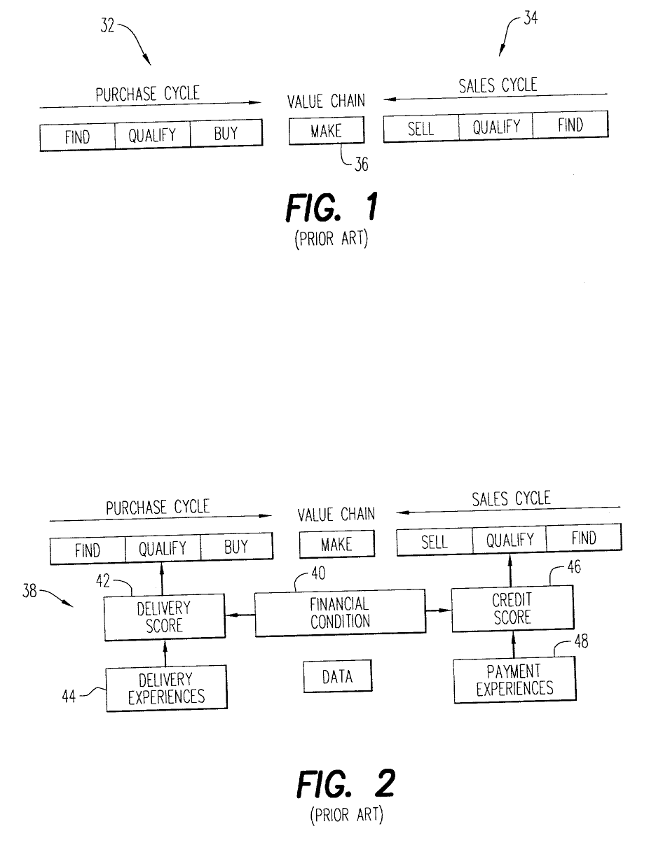

### DESCRIPTION OF THE PREFERRED EMBODIMENT

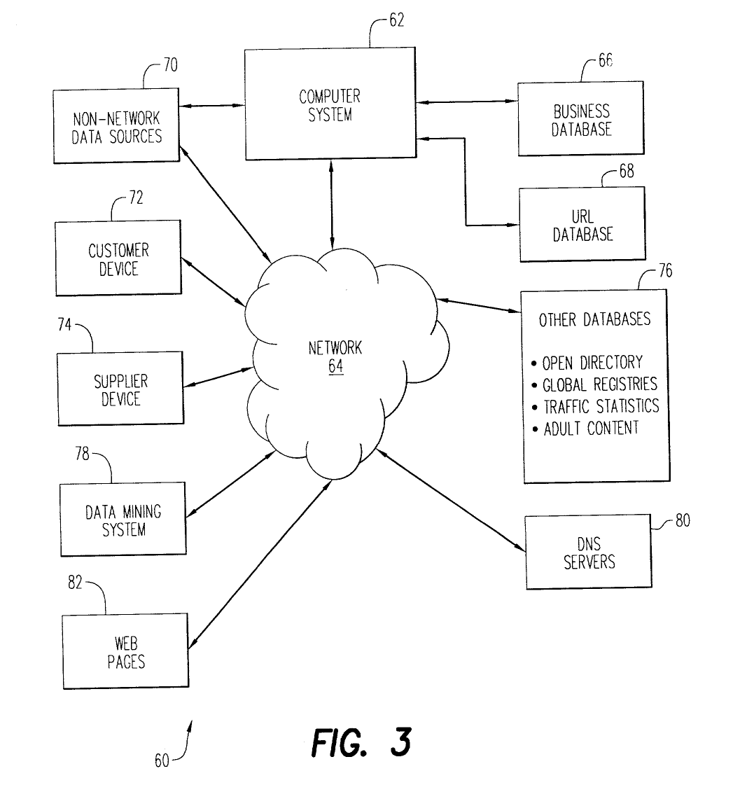

Referring to FIG. 3, a communication system 60 includes a computer system 62, a network 64, a business database 66, a URL database 68, a plurality of other databases 76, non-network data sources 70, a customer device 72, a supplier device 74, a data mining system 78, a plurality of domain name servers (DNS) servers 80 and a plurality of web pages 82. Network 64 interconnects computer system 62, other databases 76, non-network data sources 70, customer device 72, supplier device 74, data mining system 78, DNS servers 80 and web pages 82. Business database 66 and URL database 68 are directly connected to computer system 62, but could be interconnected via network 64. Non-network data sources 70 comprise traditional data collection facilities that can communicate data via network 64 or other means, e.g., the postal service or a courier service, shown by the dashed connection to computer system 62.

Network 64 may be any wired or wireless communication network capable of conducting communications. For example, network 64 may be an Internet, an Intranet, the World Wide Web (hereinafter referred to as the “WWW” or the “Web”), the public telephone network, other networks and any combination thereof. Network communication capability, such as modems, browsers and/or server capability (not shown) is associated with each device interconnected with network 64.

Customer devices 72 and/or supplier device 74 may be any suitable device upon which a browser may run, such as a personal computer, a telephone, a television set, a hand held computing device and the like. Alternatively, customer devices 24 may communicate with computer system 62 via off-line connections (not shown). It will be appreciated by those skilled in the art that, though only one customer device 72 and only one supplier device is shown, more of each is possible.

Computer system 22 may be any suitable computer, presently known or developed in the future, that is capable of communicating in a protocol that is compatible with the browser capabilities of customer device 72 or supplier device 74 and that is capable of running applications as described herein. Computer system 22 may be a single computer or may comprise a plurality of computers that are interconnected directly or via network 34.

Database 66 includes a data collector's data framework with each business being identified by a business ID. For example, database 66 might include the data framework and business data of D&B. Each business in the data framework would then be identified by a DUNS number.

Computer system 62 and business database 66 operate to provide via network 64 pertinent business data concerning one or more of a plurality of businesses in reply to a request from customer device 72. Alternatively, the requests and pertinent business data could be exchanged via a postal service, telephone, facsimile, courier and the like. Traditionally, data to update current files or build new files has been obtained via non-network sources 70. These sources include, for example, personal contact with customers or with prospective businesses. Business database 36 is referred to herein as a single database, by way of example, even though it may be a single database or a plurality of databases.

Other databases 76 include various databases that provide useful data concerning businesses. For example, other databases 76 include one or more databases that contain a directory of URLs. One example of an URL directory database is called Open Directory. Other databases also contain global registries, such as domain registries. DNS servers include a plurality of servers that serve web pages, such as web pages 32, via network 34. Web pages 34 include all web pages that have a web address or a uniform resource locator (URL) and include the web pages of businesses. Data mining system 30 may include one or more commercial data mining services that access data from databases and extract desired data therefrom.

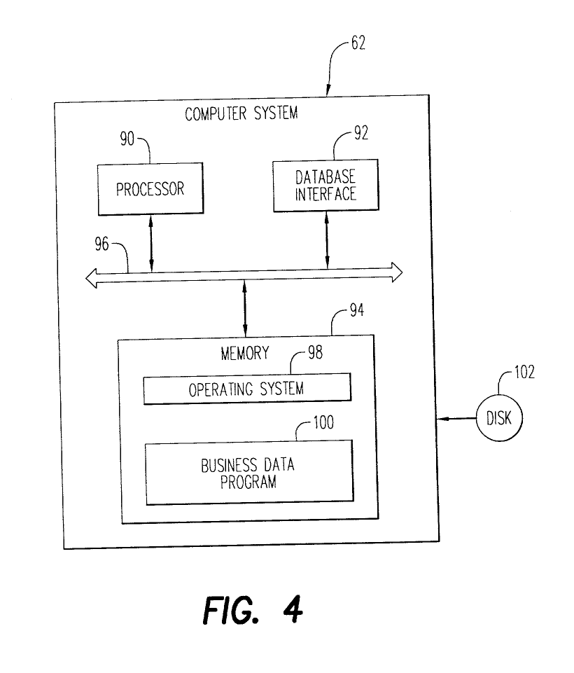

Referring to FIG. 4, computer system 62 includes a processor 90, a database interface unit 92 and a memory 94 that are interconnected via a bus 96. Memory 94 includes an operating system 98 and a business data program 100. Other programs, such as utilities, browsers and other applications, may also be stored in memory 94. All of these programs may be loaded into memory 94 from a storage medium, such as a disk 102.

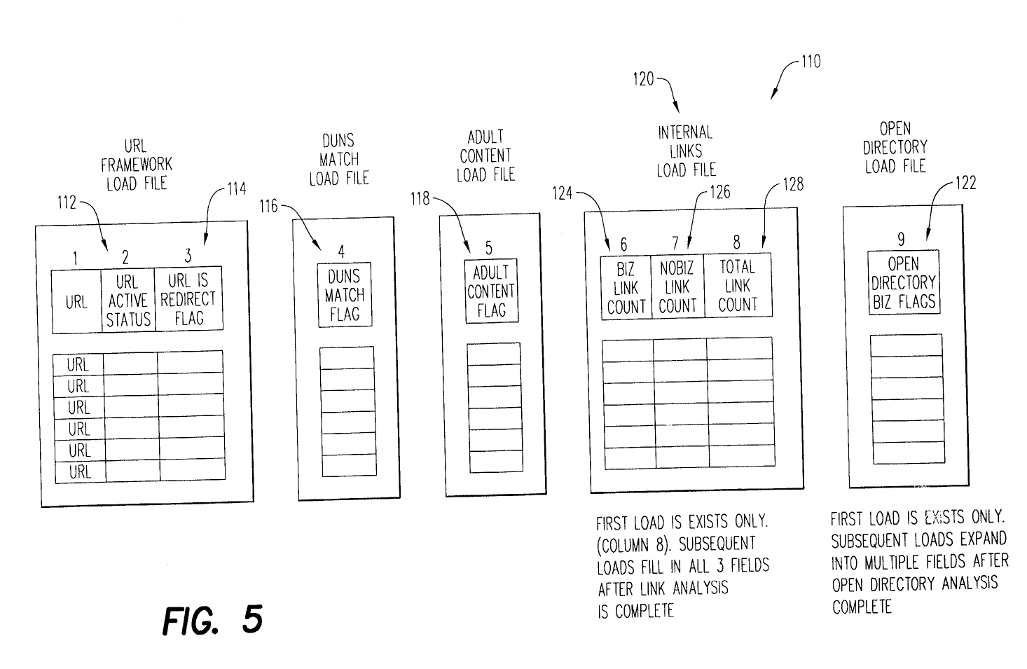

Referring to FIG. 5, URL database 68 includes a data framework or structure 110 that can be described in terms of a spreadsheet having a row for each URL and separate columns for various data elements or attributes thereof. The attributes include active status 112, redirect flag 114, DUNS match flag 116, adult content flag 118, internal links 120 and open directory business flags 122. Internal links 120 include business link count 124, no business link count 126 and total link count 128. Other columns include other attributes, such as business name, business address, products, services, and the like.

Processor 50 is operable under the control of operating system 58 to run business data program 100 to collect business data elements or attributes obtained from other databases 76, DNS servers 80 and web pages 82. These attributes are used to build, populate and update URL database 68, validate current DUNS number data and update current files in business database 66 and URL database 68. Data program 100 uses the data of URL database 68 to identify business entities and makes determinations of whether the entities have a critical mass of business attributes so as to qualify for assignment of a business identifier for inclusion in business database 66. Data program 100 also uses the data of business database 66 and/or of URL database 68 to drive data mining system 78 to obtain additional data from other databases 76, DNS servers 28 and/or web pages 32. This data updates business database 66 or URL database 68.

Assigning business IDs includes sweeping URL database 68 and looking at the values in the columns for each URL. For example, if a given URL has many inbound links, if its internal links are business related, if it has traffic and a human in the Open Directory has classified it as a business, it almost certainly is a business and can be given a business flag. The universal entity ID is the URL itself, and the business flag is a one-byte field (yes/no).

URL database 68 can be evaluated periodically and all of the business flags re-assigned en-masse. This is easily done by executing a simple SQL query for each database row against the given set of “evidence” columns (fields). The business flags themselves may change, but the primary entity ID (the URL) is not tied to these flags and does not change.

As a practical matter, URL database 68 can be re-evaluated on a daily basis and the business or non business status of each URL will be as current as the last set of inputs. Since the primary use of the URL database is for marketing and sourcing applications, it is not a critical problem if a given URL changes status. However, since the default condition is non-business, and positive evidence to the contrary is required to classify a URL as a business, the most likely situation is the URLs formerly classified as non-business will become classified as businesses. This effectively increases the overall URL business universe and brings increased benefits to marketing and sourcing applications.

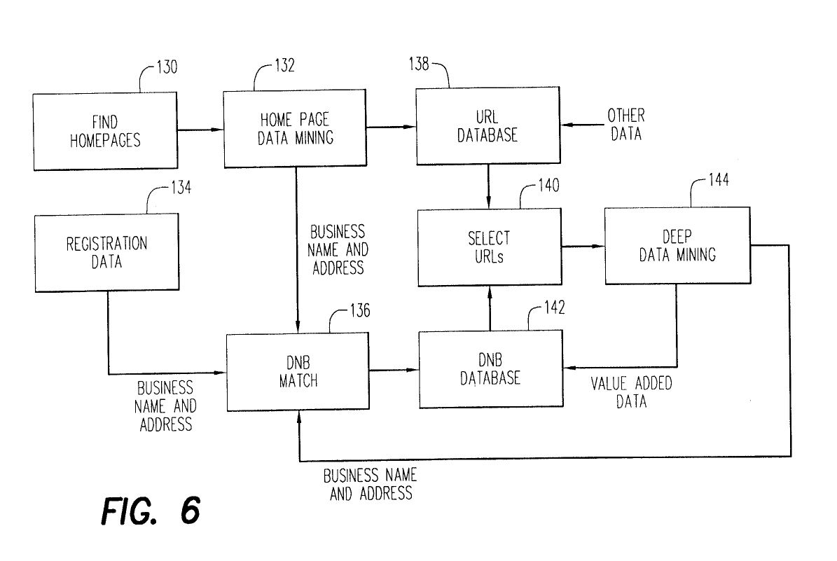

Referring to FIG. 6, the data collection process begins at step 130, which finds home pages. Home pages are found by obtaining a copy of a “zone file” from the Internet body charged with keeping the centralized registry of domain names. In the United States, the Internet body is NSI (Network Systems Inc.). The zone file contains the URL of every web site home page in the net, org, and corn domains. It also contains a reference to an individual DNS server that holds the network (IP) address associated with the URL. Step 130 finds and obtains the IP address for a given URL by accessing the DNS server indicated by the zone file. Step 130 is repeated for each URL in the zone file.

Step 132 then uses the IP address to access the home page of the URL for various attributes of the URL database. Step 138 builds, populates or updates the entries in URL database 68 with the mined attribute data. It is also possible to find business name and address data on some home page sites. If found, the business name and address data is used by step 136 for comparison with the DUNS entries in business database 66.

In a parallel flow, step 134 accesses one or more registries for URL (domain name) registration data. This registration data has the URL already associated with a business name and address. Step 136 compares this registration data with the DUNS entries in database 66. If a match is found, step 142 validates and/or updates attributes of the matched DUNS entry.

Steps 130, 132, 134, 136, 138 and 142 are performed on an ongoing basis so as to continuously populate URL database 68 with critical information. Periodically, step 140 launches one or more “deep” data mining operations by selecting URLs based on a combination of criteria derived from URL entries in URL database 68 and DUNS entries in business database 66. For example, the following mining processes may be launched:

1. URLs that are not matched to DUNS Numbers are mined to see if business name and address information can be obtained to do a match. Criteria for this process is an “unmatched” status in business database 66 and an “active” status with a business flag in URL database 68.

2. URLs that are matched to DUNS Numbers are mined to confirm that the business name and address on the web site is the same as the business name and address in business database 66. Criteria for this process is a “matched” status in business database 66 and an “active” status in URL database 68.

3. URLs for large companies are mined to collect contact names and addresses. Criteria for this process is a large company indication from business database 66 (revenue or number of employees) with a “matched” status, and an “active” status from URL database 68.

4. URLs for electronic commerce web sites are mined to collect electronic commerce information. Criteria for this process is an “active” status and “have secure certificate” status in URL database 68, and a “matched” status from business database 68.

New business name and address data associated with URLs from the fourth data mining process above is used by step 136 to determine a match with a DUNS entry in business database 66. Data from the third and fourth data mining processes above were based on matched URLs to begin with and already carry Duns Numbers. This data can, therefore, bypass the matching process of step 136 and go directly into business database 66 after suitable quality checks.

Other deep data mining operations can be designed that look for new kinds of data not previously collected. The new kinds of data is termed value-added data in FIG. 6 and represents new business opportunities.

The data elements necessary to answer the basic business differentiation questions are generally available on the Web for collection by business data program 100 for population of URL database 68. The “what do they do” question can be answered by classifying URLs into various categories. This classification currently exists for about 2 million web sites in the Open Directory and numerous other web classifiers. The Open Directory may be used by anyone for any purpose as long as attribution is given. Other directories can also be easily accessed and all directories, including the Open Directory, can eventually be mapped into one meta-classification.

The “how big are they” question can be answered by collecting revenue and size parameters. One attribute of size is business link count 124 (FIG. 5), which is a measure the number of inbound links to a web site. Many inbound links indicate that many people have taken the time to physically establish a hyperlink between their site and the target or web site. This means that the target site is probably doing a lot of business, and, thus, is “big” in the on-line sense. Another, and complementary measure of size is the number of hits to the site. This data can be obtained from various vendors like Direct Hit.

The “where are they located” question may or may not be relevant in the online world. Many goods and services delivered over the web, such information, books, small hardgood items and the like are location insensitive in that people don't care where the business is located as long as the products or services can be delivered well and fast.

Some goods (like furniture) and services (like personal or household services) are location sensitive. These goods and services may still be sold online, but the actual use of these goods and services happens offline at or near the customer's home. However, as it turns out, a number of vendors, like Quova, are bringing out services that determine the physical location of the business (the web server at least) by pinging the server from various locations and then triangulating response times. These services claim to be able to isolate server locations down to the Zip Code level. Of course, where the server is not located near the business this could cause a problem, but this might well be a corner case that can be handled by data mining the firm's location off of their web page.

Elements required to establish contact with the business are somewhat different. In traditional businesses contacts are the CEO or functional manager contact names, the physical (snail mail) address, and the telephone number. In non-Web transactions, these personal contacts with these individuals is necessary to sourcing and marketing activities. On the Web, this contact will take place primarily by email and functional emails might suffice in most cases. Where they do not, individual contact names and titles can often be mined directly from the web site.

Data elements, such as Open Directory classifications, inbound links, and traffic indicate that the URL at least existed at some point in time and are some evidence of potential classification as a business. Another powerful piece of evidence about the business or non-business status of a site comes from an examination of the site's internal links. Links are of the form URL/Path where path is usually an (semi) English language description of where you can go. For example, links to “mysite/customer service” or “mysite/products” or “mysite/management team” are a good indication that the site is business oriented. These links can be automatically mined and categorized by business keyword.

Finally, URLs are examined on an ongoing basis by numerous groups of people and by numerous automated agents running on the web for evidence of adult or other inappropriate content. These sources supply the data to populate attribute 118 of data framework 110. One can safely assume that these specific URLs are not businesses (even though their parent organizations often are), and by getting a list of these URLs they can all be classified as non-business.

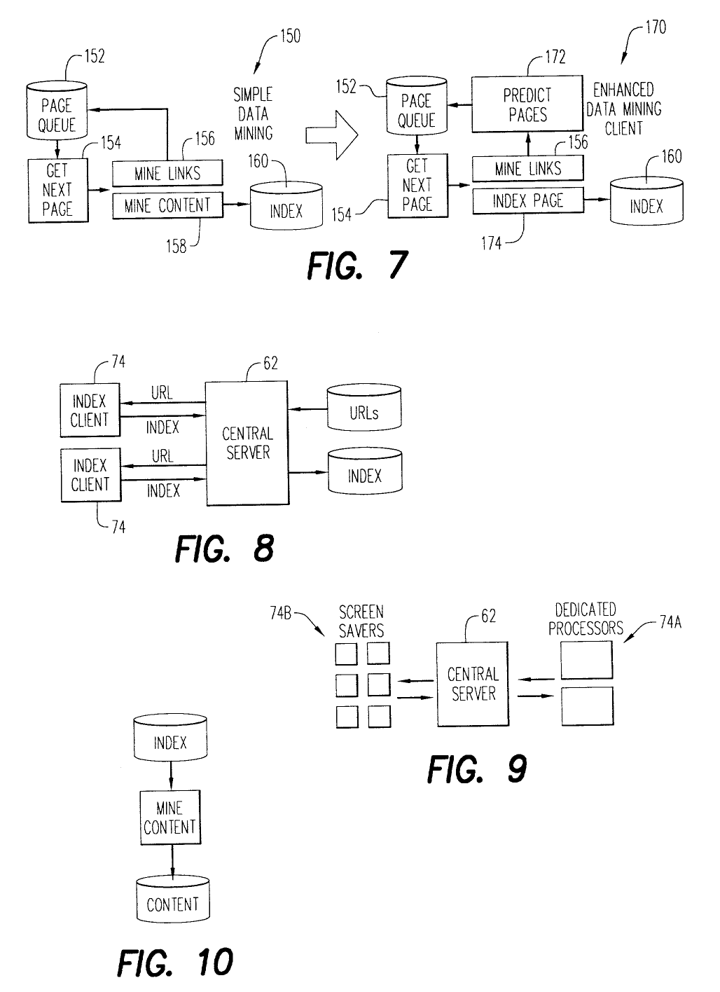

Referring to FIG. 7, a simple data mining system 150 and an enhanced data mining system 170 are shown. The basic purpose of data mining systems is to go to access a given web site, start at the top with the home page and work downwardly to subordinate pages, extracting relevant information along the way. Each page of the web site is identified by a page address that combines the URL of the site with more detailed information called the “path.” For example, the page address of the contact page on dnb.com might be dnb.com/contact_us, where the URL is “dnb,” and the path is “contact_us.”

Any given web page contains content (useful information) and/or addresses of other pages (links). When mining any web page data mining systems 150 and 170 mine both content from the page as well as the links to other pages. Simple data mining system 150 begins this process at step 152 by accessing the web site and forming a queue of the pages at the site. Step 154 gets the next page from the queue. Steps 156 and 158 examine each and every word on the page to identify links and content.

Links are found by looking for any word with the sequence of letters that indicates the start of a link to another page. This sequence of letters is “http://,” and the words that follow will be a link to another page (URL and path). If the URL is the same as the URL of the current site, the link is an internal link to deeper pages on the site, and the entire string is written to the page queue for subsequent processing by the data mining system.

Step 158 examines each word that is not a link to determine if it contains useful content. Each type of content will have its own specific set of rules. For example, consider one of the several rule sets used to extract US address information. This rule set says that if a word consists of two capital letters (NY, NJ, etc), and the next word is a five digit number (07704, 12120, etc), then this combination of words is probably part of an address string. To pull the entire address string out, go back to the words before the two capital letters and they are, from right to left, the city, street name, and street address. Once identified, this content is then written to a content file along with the complete address of the page where it was found. Once step 158 has applied all of the multiple content rule sets to every word on a given page step 154 gets the next page from the page queue. Simple data mining process 150 continues until every page on the web site has been mined, or until some arbitrary depth level set by the user, for example, 3 levels deep, has been reached.

A primary problem with simple data mining is that incredible processing volumes are involved. As of June 2001, the Web is estimated to contain about 4 billion pages. Most published literature puts the size of an average web page at 10 thousand bytes, so the total size of the web is at least 40 terabytes. Just downloading this much information on a 45 megabit per second T3 line would take 82 days, not to mention the processing power required to do a word-by-word analysis of 30 terabytes of data.

Clearly, some additional strategies are needed other than just mining every web page. The present invention provides several such strategies that can be used separately or together. One strategy is to mine only business related web sites. For instance, step 140 of FIG. 6 selects only those URLs that exhibit one or more business attributes for the deep data mining of step 144.

Another strategy is to mine only those pages that are likely to contain business information. This is accomplished by examining the path component of the page address as it is mined to determine if the words or phrases contained therein are indicative of the required business content. For the example of dnb.com/contact_us, the path component is “contact_us”. To determine what words or phrases are likely to yield information, pages that contain already mined data are examined. The paths for these pages can be analyzed by keywords and phrases to develop a set of rules predicting what paths are most likely to yield what data. With a large enough data sample, prediction rules should be able to catch a significant fraction of pages with desired content. For example, “corporate officers” is likely to yield contact names and titles, “contact us” is likely to yield addresses and phone numbers, and so on. This strategy is called page prediction and is performed by step 172 of enhanced data mining 170 in FIG. 7.

Once non-business web sites have been eliminated and probable nonbusiness pages have been eliminated by step 172, there is still a huge amount of processing required to scan the entire web for business information. If this processing is all done centrally it will require a very large processing complex and a very large bandwidth. Another strategy of the present invention is to deploy the data mining across a distributed processing network. Web mining is inherently parallel because every web site can be mined separately, and it is inherently distributed because access to web pages is equally available to anyone with an Internet connection.

According to an aspect of the invention, computer system 62 of FIG. 3 serves the homepage URLs of sites to be mined to a series of parallel and distributed clients, such as supplier devices 74. Each supplier device 74 mines the web page of the URL that was served to it and returns mined data to computer system 62. Ideally, some of these supplier devices will be widely distributed across many businesses and personal host machines and use both spare processing power and spare bandwidth.

A problem in integrating such a system is complexity. The information streams sent between supplier devices 74 and computer system 62 need to be very simple and standard. Any one supplier device 74 should not have to do excessively complex operations. Mined data elements vary by type of data. The length of each element is variable. The number of element occurrences can vary. For example, address information contains street number, street, city, state, and zip. Some of these fields can be of any length, and the number of occurrences from a given web page can vary from one to several (if, for example, the page contains a list of branch locations). Contact name information contains a person's name and title, which can also be of any length. The number of occurrences can also vary widely—from a just a few for small companies with small management teams, to hundreds for some major sites that list all of their significant managers. Other types of business information are similarly variable.

Thus, distributing a content mining system that produces large volumes of complex and variable data content, while possible in theory, could be very difficult in practice. Another aspect of the present invention is to reduce this complexity by indexing each page before mining. If each page is first indexed rather than mined, the index data produced can be limited to a single byte for each type of data. This byte will hold the number of occurrences of each type of data on the page. In this way, the index of information on a page can be held in a small number of bytes (usually under 10), and an index page can be completely described by URL/Path/Index Bytes.

Each supplier device 74 on a distributed indexing system receives the URL to be mined from computer system 62, and returns the same standard 3 data elements for each page mined: URL/Path/Index Bytes. Thus, messages both ways are extremely simple and standard, and the amount of data exchanged between computer system 62 and distributed supplier devices 74 is minimal. Of course, every indexed page containing business data will have to be re-mined to get the detailed content rather than just the index. To illustrate, if 1,000 web pages are indexed, and 10% or 100 pages have business information, these 100 pages will have to be re-mined to get the content. This results in a total of 1,100 pages to be mined. However, 1,000 of these pages could be done in a distributed processing environment and the hypothesis is that this would more than make up for the extra 100 pages. A one-pass data mining system would mine only 1,000 pages but they could not be done in a distributed environment for reasons already mentioned.

The set of rules for analyzing page addresses is entered into computer system 62 by an administrator. Business data program 100 processes the mining of web pages according to these rules. Specifically, as a page link is mined by step 156 (FIG. 7), page prediction step 172 examines the page address (specifically the path name) to determine if it is a likely business candidate. If so, the page is written to the page queue by step 152 for subsequent analysis. If not, the page is discarded.

For page indexing, content only has to be identified, not extracted. For example, the rules for the aforementioned content mining example for the mining of a United States business address are:

1. If a word consists of two capital letters (NY, NJ, etc), and the next word is a five digit number (07704, 12120, etc), then this combination of words is probably part of an address string.

2. To pull the entire address string out, go back to the words before the two capital letters and they are, from right to left, the city, street name, and street address.

3. This content is then written to a content file along with the complete address of the page where it was found.

For page indexing step 174, rule number one is maintained because it identifies data to be mined. This is the basis of the indexing flag. Rule number two is not required because it explains how to extract data. Rule number three is changed from writing the data content to a file to writing the fact that the data exists to the single indexing byte for that page.

Referring to FIG. 8, computer system 62 under control of business data program 100 acts as a central server to serve URLs in the form of URL/Path to supplier devices 74. Supplier devices 74 return to computer system 62 three data elements for each page mined, namely, URL/Path/Index Bytes. Computer system 62 then assembles the returned information from all supplier devices 74 into a consolidated index database that contains only these three elements.

Referring to FIG. 9, supplier devices 74A can be built to run in any processing environment, such as dedicated processors. Other supplier devices 74B can be built to run as screen savers to take advantage of unused bandwidth and processing power of various host computers. Computer system 62 handles the I/O to each supplier device 74A and 74B, balances the workloads, and takes care of situations where any supplier device 74A or 74B is not responding.

Referring to FIG. 10, after all indexing is done, step 180 determines and retrieves the exact indexed pages with business data content for content mining. Step 182 mines the content of these pages. Step 184 stores the content in a content file, which is used by business program 100 to populate business database 66 and URL database 68 of FIG. 3.

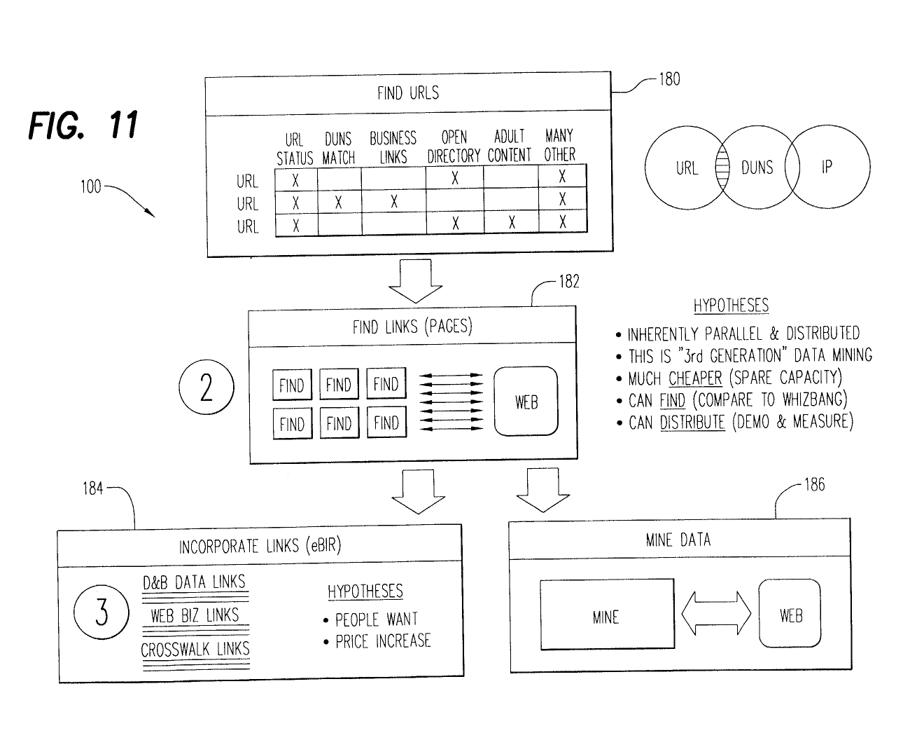

Referring to FIG. 11, business data program 100 includes step 180 that finds URLs. Step 180 includes step 130 of FIG. 6 that obtains URLs from a zone file. Step 182 serves the URLs to supplier devices 74 and receives back the aforementioned data consisting of URL/Path/Index Bytes. Step 184 incorporates links identified by the Index Byte into an ebusiness web site that is capable of rendering business reports. Step 186 uses the link and other data identified in the Index Byte to mine additional data from other databases 76 and web pages 82.

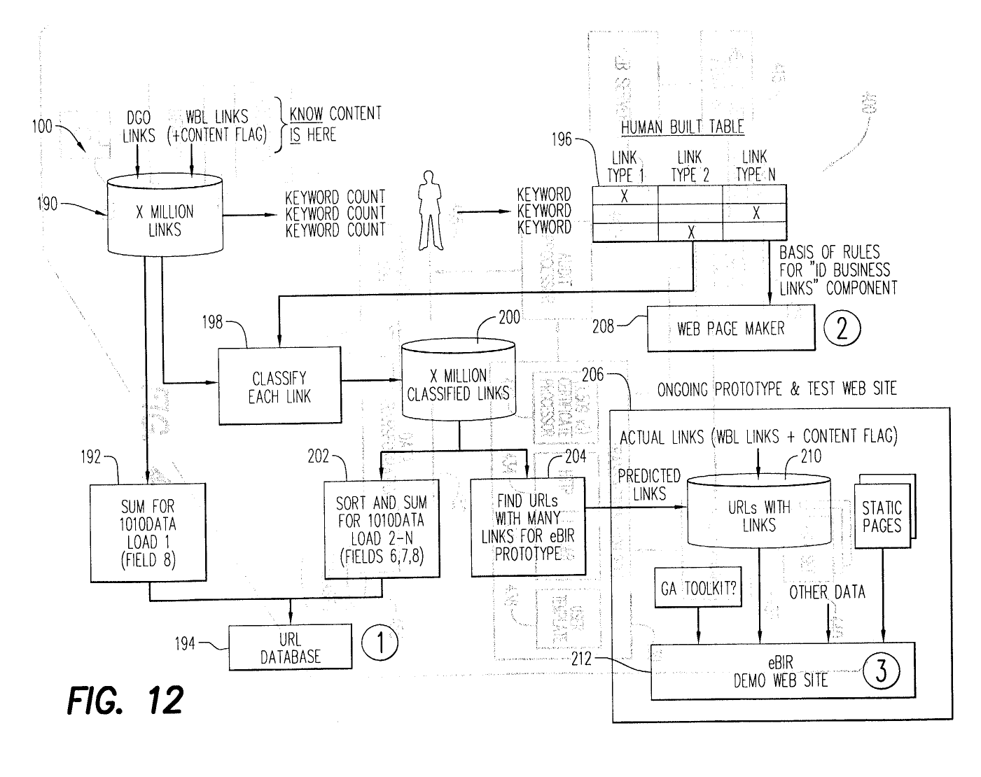

Referring to FIG. 12, business data program 100 includes step 190 that receives link data from the Index Bytes (WBL links and content flag) as well as from other sources (DGO links). Step 192 processes the link data to calculate the sums for the total link count column 128 of the URL database 68. Step 194 stores the total count values in URL database 68. Step 196 extracts the content data from the Index Bytes and classifies by link type. Step 208 processes the link type data for further data mining. Step 198 classifies each link of step 196. Step 200 forms a file of the classified links. Step 202 sorts and sums the classified links to form the data for internal links 120 of the URL data framework 110. Step 194 stores the sorted and summed data into columns 124, 126 and 128 of the data framework in URL database 68. Step 204 finds URLs with many links to ebusiness. Step 206 processes the URLs found by step 204 to provide ebusiness services. Step 206 includes steps 210 and 212. Step 210 forms a file that includes the ebusiness URLs of step 204 and the Index Byte data that contains a content flag. Step 212 uses the data of step 210 to provide ebusiness services, such as providing business reports to customer device 72 (FIG. 3)

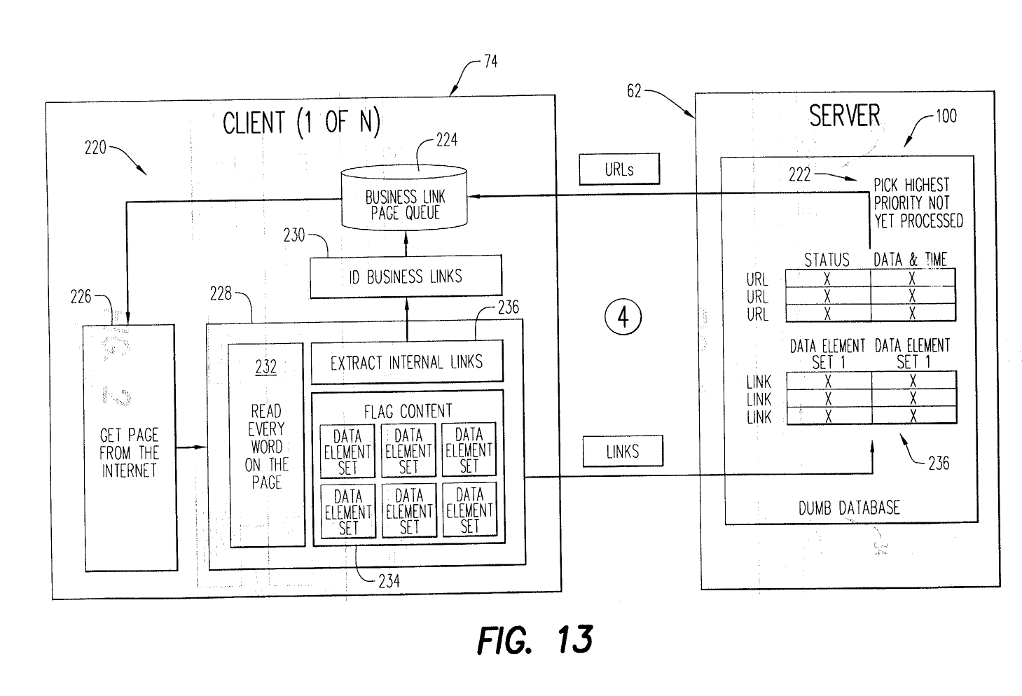

Referring to FIG. 13, computer system 62 serves URLs to a supplier device 74. Business program 100 of computer system 62 includes step 222 that selects the highest priority URL that has not yet been served for serving to supplier device 74. Step 236 receives the Index Byte from supplier device 74 and extracts the data element or flag content therefrom.

Supplier device 74 includes an indexing program 220. Indexing program 220 includes step 224 forms a business link page queue with the URLs received from computer system 62. Step 226 accesses and gets the next page of the queue from the Internet. Step 228 processes the web page data to form the Index Byte that is returned to computer system 62. Step 128 also identifies any internal links to other web pages. Step 230 identifies any of the internal links that are business links and provides the URLs thereof to step 224 for addition to the queue.

Step 228 includes steps 232, 234 and 236. Step 232 reads every word on the web page. Step 236 extracts internal links thereof. Step 234 identifies flag content based on different data element set types, assembles the flag content into the Index Byte for return to computer system 62.

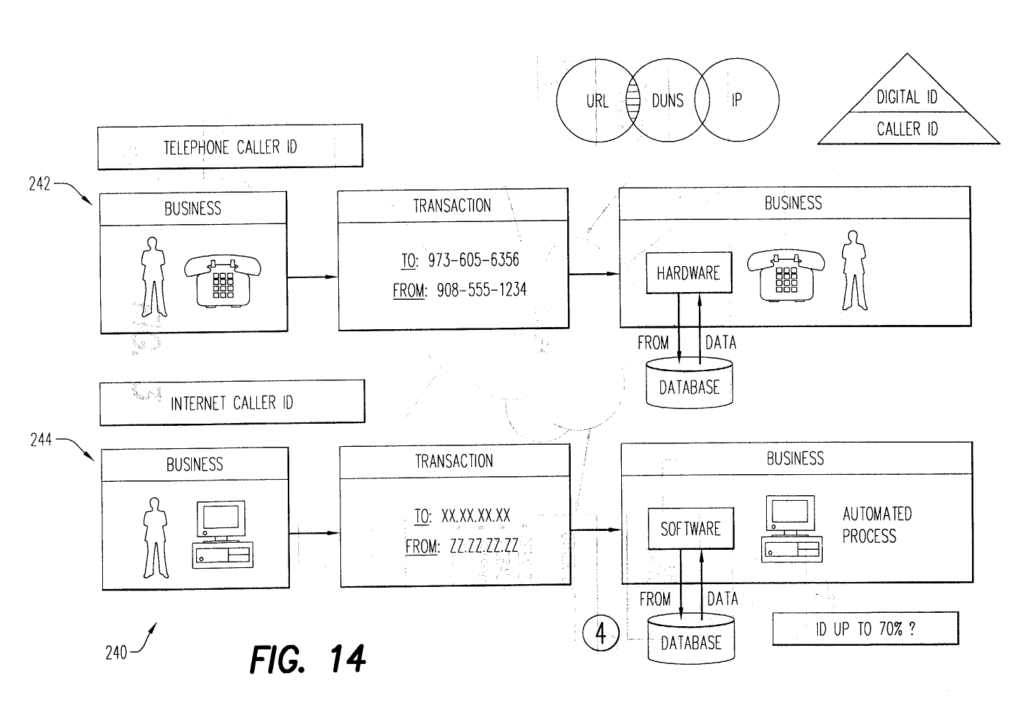

Referring to FIG. 14, a caller ID system 240 includes a telephone caller ID 242 and a digital caller ID 244.

The present invention having been thus described with particular reference to the preferred forms thereof, it will be obvious that various changes and modifications may be made therein without departing from the spirit and scope of the present invention as defined in the appended claims.

What is claimed is:

1. A method of verifying business data comprising:
(a) looking up a first profile data for a business using at least one URL;
(b) looking up a second profile data for said business using a business identifier; and
(c) comparing said first profile data and said second profile data, thereby verifying that said second profile data is valid.

2. The method of claim 1, further comprising:
(d) updating said second profile data with any of said first profile data that differs from said second profile data.

3. The method of claim 1, wherein said first profile data and said second profile data each include a plurality of data elements, wherein one or more of the data elements of said plurality of data elements is one of the group consisting of URL, business identifier, business name, and business address, and wherein step (c) compares the one or more data elements of the first and second profile data.

4. The method of claim 1, further comprising:
(e) obtaining from one or more sources connected to a network additional profile data for said business; and
(f) updating said second profile data with said additional profile data.

5. The method of claim 4, wherein step (e) obtains an IP address that corresponds to said URL and uses said IP address to access a web page for said business to obtain said additional profile data.

6. A method of developing new business profile data comprising:
(a) looking up a first profile data for a business using at least one URL;
(b) looking in a database for a second profile data for said business using one or more data elements of said first profile data; and
(c) if said second profile data is not found, determining if said first profile data qualifies as a business and, if so, assigning a business identifier thereto to form said new business profile data.

7. The method of claim 6, further comprising:
(e) obtaining additional profile data for said new business from one or more sources connected to a network; and
(f) updating said new business profile data with said additional profile data.

8. A method for processing profile data, wherein said profile data includes separate profile data records for a plurality of business concerns, wherein each of said profile data records includes a plurality of data elements, and wherein each of said profile data records is identified by a business identifier, said method comprising:
(a) comparing a plurality of URL data with said profile data, wherein said URL data includes a plurality of URL data records, and wherein each of said URL data records includes a URL and at least one business data element for a business concern;
(b) developing a plurality of unmatched URL data records, wherein said at least one business data element is unmatched to any data element in said plurality of profile data records;
(c) using the URL of a first one of said unmatched URL records to locate on a network one or more sites that contains additional business data elements for said first URL record;
(d) adding said additional data elements to said first unmatched URL record; and
(d) determining if said updated first unmatched URL record qualifies as a business and, if so, assigning a business identifier thereto and adding to said plurality of data records for a plurality of business concerns.

9. The method of claim 8, further comprising;
(f) accessing said profile data records by said business identifiers to produce a business report.

10. The method of claim 9, wherein step (c) comprises the steps of:
(c1) obtaining an address of a server for said URL of said first unmatched URL record;
(c2) using said server address to obtain from said server an IP address; and
(c3) using said IP address to access a web page for a business concern of said first unmatched URL record and obtain said additional business data elements.

11. A method for mining data from a plurality of resources connected to a network, said method comprising:
(a) maintaining a plurality of URL records in a first database that includes a plurality of fields for each URL record;
(b) maintaining a plurality of business data records in a second database that includes a plurality of fields for each business data record; and
(c) deriving a mining strategy from data elements stored in one or more of the fields of said first and second databases to mine data elements from said plurality of resources for storage in the fields of said first database.

12. The method of claim 10, further comprising:
(d) determining if the data elements of a first URL record of said first database describe a business and, if so, forming a new business data record based on the data elements of said first URL record for storage in the second database and assigning a new business identifier thereto.

13. The method of claim 10, further comprising:
(e) providing business reports based on the data elements of either said first database, said second database, or both.

14. The method of claim 10, wherein steps (a) and (c) populate and/or update the fields of said first database.

15. A method of processing the content of a web page comprising:
(a) arranging the content of said web page into a plurality of content categories; and
(b) forming an index that summarizes said content categories.

16. The method of claim 15, wherein said index is a small number of bytes.

17. The method of claim 15, wherein said content categories are expressed as values.

18. A data mining system comprising:
means for serving a URL; and
at least one supplier device for forming an index of the content of a web page indicated by said URL and returning said index to said serving means.

19. A method of filtering a plurality of web pages for mining a business content comprising:
(a) eliminating any of said plurality of web pages that contain adult content;
(b) eliminating any of said plurality of web pages that do not pass a predictability test of containing business content; and
(c) mining any of said plurality of web pages remaining after steps (a) and (b) for business content.

20. A computer system that verifies and develops business profile data, said computer system comprising:
first look up means for looking up a first profile data for a business using at least one URL;
second look up means for looking for a second profile data for said business using a business identifier;
compare means for comparing said first profile data and said second profile data, if said second profile data is found, thereby verifying that said second profile data is valid; and
establishing means for establishing said second profile data with said first profile data if said second profile data is not found.

21. The computer system of claim 20, further comprising:
means for assigning a business identifier to said second profile data.

22. The computer system of claim 20, further comprising:
means for establishing a data mining procedure to obtain from one or more sources connected to a network additional profile data for said business; and
update means for updating said second profile data with said additional profile data.

23. The computer system of claim 22, wherein said means for establishing comprises:
means for obtaining from a global registry of URLs an address of a server for said URL;
means for using said server address to obtain from said server an IP address; and
means for using said IP address to access a web page for said business and obtain said additional profile data.

24. The computer system of claim 23, wherein said means for establishing further comprises:
means for using a spider to obtain said additional business data elements from said web page.
